(19) United States
(12) Patent Application Publication
(10) Pub. No.: US 2013/0311751 A1
(43) Pub. Date: Nov. 21, 2013

(54) SYSTEM AND DATA LOADING METHOD

(71) Applicant: FUJITSU LIMITED, Kawasaki-shi (JP)

(72) Inventors: Koji KURIHARA, Kawasaki (JP); Koichiro YAMASHITA, Hachioji (JP); Takahisa SUZUKI, Kawasaki (JP); Hiromasa YAMAUCHI, Kawasaki (JP); Fumihiko HAYAKAWA, Kawasaki (JP); Naoki ODATE, Akiruno (JP); Tetsuo HIRAKI, Kawasaki (JP); Toshiya OTOMO, Kawasaki (JP)

(73) Assignee: FUJITSU LIMITED, Kawasaki-shi (JP)

(21) Appl. No.: 13/949,858

(22) Filed: Jul. 24, 2013

Related U.S. Application Data
(63) Continuation of application No. PCT/JP2011/051355, filed on Jan. 25, 2011.

(51) Int. Cl. G06F 9/38

(52) U.S. Cl. CPC G06F 9/3877
USPC 712/28

(57) ABSTRACT

A system includes plural processors; memory that stores a program currently under execution by the processors; and a pre-loader that pre-loads into a fragment area of the memory, a target program that is to be executed and is a program other than the program currently under execution by the processors.

### CROSS REFERENCE TO RELATED APPLICATIONS

This application is a continuation application of International Application PCT/JP2011/051355, filed on Jan. 25, 2011 and designating the U.S., the entire contents of which are incorporated herein by reference.

### FIELD

The embodiments discussed herein are related to a system and a data loading method.

### BACKGROUND

Conventionally, when a user starts up an application to be executed, a program of the application is loaded from storage to memory, which may consume considerable time, causing the response to the user to drop.

According to a known technique, the start-up time of an application to be executed is estimated based on the execution history of the application; and the application is loaded before the estimated start-up time (see, for example, Japanese Laid-Open Patent Publication No. 2005-275707).

However, if the application to be executed is loaded before a start-up instruction is issued for the application, the data of an application currently under execution may be swapped. The area to which the application is to be loaded may already be used for the processing of the application currently under execution, depending on the type of the processing. In this case, the context information of the loaded application to be executed is swapped. Although the application to be executed is loaded on RAM before the start of the starting up thereof to expedite the start of the starting up, the application to be executed is swapped. Therefore, a problem arises in that the context information needs to again be stored from the storage to the RAM when the starting up is started. If the area onto which the application is loaded is protected to prevent the swapping of the application that is loaded in advance, the usable memory area for the application currently under execution is limited. Therefore, another problem arises in that performance drops.

### SUMMARY

According to an aspect of an embodiment, a system includes plural processors; memory that stores a program currently under execution by the processors; and a pre-loader that pre-loads into a fragment area of the memory, a target program that is to be executed and is a program other than the program currently under execution by the processors.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of an embodiment;

FIG. 2 is a block diagram of hardware of a multi-core processor system;

FIG. 3 is a block diagram of a functional configuration of a multi-core processor system 200;

FIG. 4 is an explanatory diagram of an example of a trigger table;

FIG. 5 is an explanatory diagram of an example of available areas of RAM 211;

FIG. 6 is an explanatory diagram of an example of a fragment area management table;

FIG. 7 is an explanatory diagram of an example of a pre-loaded app management table;

FIG. 8 is an explanatory diagram of an example of assignment of parallel pre-loaders;

FIG. 9 is an explanatory diagram of an example of execution of an app #A;

FIG. 10 is an explanatory diagram of the available areas of RAM 211 after execution of the app #A;

FIG. 11 is an explanatory diagram of an example of updating of a fragment area management table 600 executed in association with a change of the available areas;

FIG. 12 is an explanatory diagram of an example of pre-loading of an app #B;

FIG. 13 is an explanatory diagram of an example of securing of a pre-loading area of the app #B;

FIG. 14 is an explanatory diagram of an example of updating of a pre-loaded app management table 700;

FIG. 15 is an explanatory diagram of an example of areas of the RAM 211 after the app #B is pre-loaded;

FIG. 16 is an explanatory diagram of execution of the app #B;

FIG. 17 is an explanatory diagram of the areas of the RAM 211 after production of context of the app #B in a first example;

FIG. 18 is an explanatory diagram of the fragment area management table 600 after the context of the app #B is produced in the first example;

FIG. 19 is an explanatory diagram of an example of updating of the pre-loaded app management table 700;

FIG. 20 is an explanatory diagram of an example where the areas for the context of the app #A are dynamically increased;

FIG. 21 is an explanatory diagram of an example of the updating of the fragment area management table 600;

FIG. 22 is an explanatory diagram of an example of the updating of the pre-loaded app management table 700;

FIG. 23 is an explanatory diagram of the execution of the app #B;

FIG. 24 is an explanatory diagram of the areas of the RAM 211 after the context of the app #B is produced in a second example;

FIG. 25 is an explanatory diagram of the fragment area management table 600 after the context of the app #B is generated in the second example;

FIG. 26 is a flowchart of an example of a procedure for a loading control process executed by a master OS;

FIG. 27 is a flowchart of an example of a procedure for a loading control process executed by each of OS; and

FIG. 28 is a flowchart of an example of a procedure for a pre-loading process executed by the parallel pre-loader.

### DESCRIPTION OF EMBODIMENTS

Preferred embodiments of a system and data loading method will be described in detail with reference to the accompanying drawings.

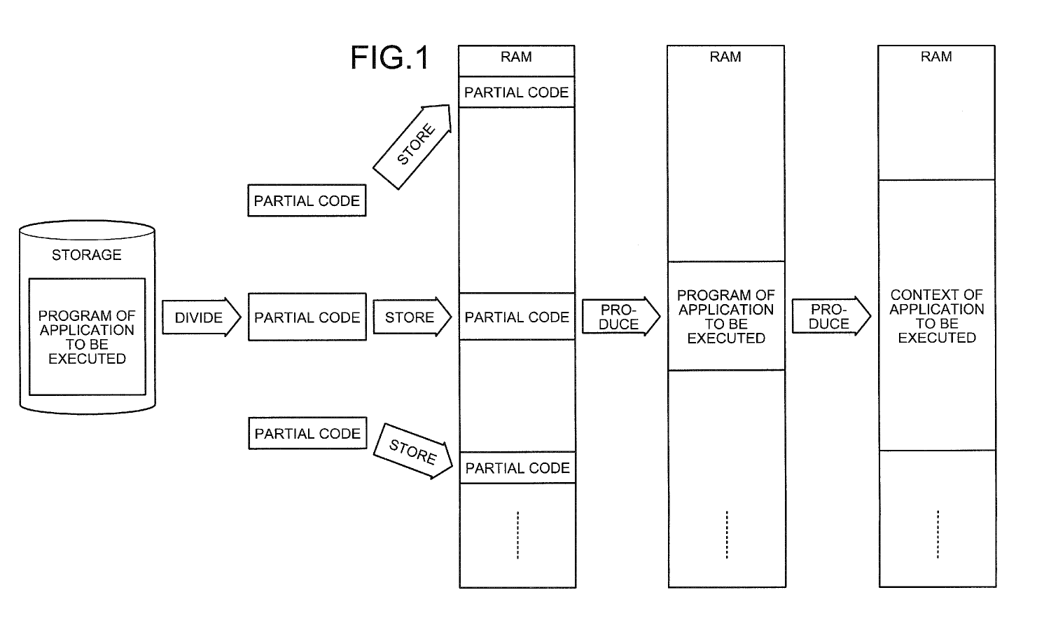

FIG. 1 is an explanatory diagram of an example of an embodiment. An operating system (OS) executed by a central processing unit (CPU) divides into code, a program of an application that is to be executed and stored in a first storage device (for example, storage). The OS identifies from among a group of available areas in a second storage device (for example, RAM), two or more available areas of a total size that is greater than the size of the program of the application to be executed. The second storage device has a higher access speed than that of the first storage. In this case, assuming that an area storable in “1 BYTE” is, for example, y [KB], the size of the area is calculated based on the address thereof. The OS distributes and stores the partial code to the two or more identified available areas.

When the OS receives a start-up instruction for the application to be executed, the OS concatenates the stored partial code to produce a context of the application to be executed on the RAM. The OS may identify from among a group of available areas that are on the RAM and respectively of a size that is smaller than a predetermined size, two or more available areas whose total size is greater than the size of the program of the application to be executed. In FIG. 1, all of the partial codes formed by dividing the program of the application to be executed are stored to the RAM. Nonetheless, configuration may be such that only a portion of the partial code is stored to the RAM.

Although the system may be a single-core system or may be a multi-core processor system, description of the embodiment will be given taking an example of a multi-core processor system. In the multi-core processor system, the “multi-core processor” refers to a processor that has plural cores. Provided that multiple cores are provided, a single processor having plural cores may be used or a group of single-core processors connected in parallel may be used. In the embodiment, for simplification of the description, the description will be made taking an example of the group of single-core processors connected in parallel.

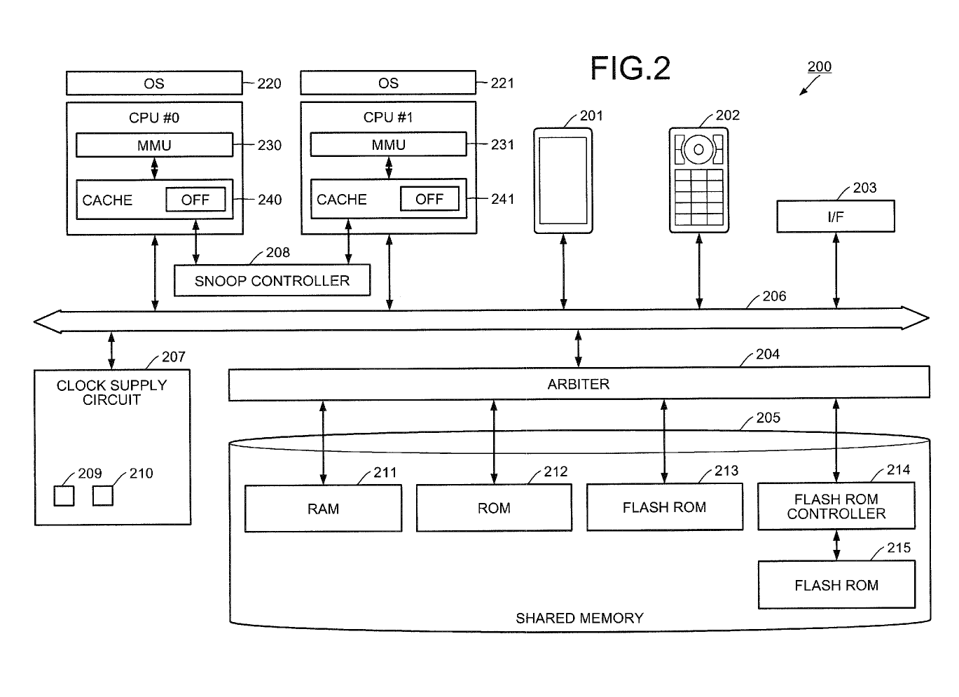

FIG. 2 is a block diagram of hardware of a multi-core processor system. In FIG. 2, the multi-core processor system 200 includes CPUs #0 and #1, a display 201, a keyboard 202, an interface (I/F) 203, an arbiter 204, a shared memory 205, and a clock supply circuit 207. The CPUs #0 and #1, the display 201, the keyboard 202, the I/F 203, and the arbiter 204 are connected to each other through a bus 206.

The CPUs #0 and #1 each include a register and a core, and respectively include caches 240 and 241 and memory management units (MMUs) 230 and 231. The cores each have a computing function. The register in each of the CPUs includes a program counter (PC) and a resetting register.

The caches 240 and 241 in the CPUs are each memory whose operation speed is higher than that of the shared memory 205 and whose capacity is smaller than that of the shared memory 205; each temporarily store data that is read from, for example, the shared memory 205; each temporarily store data to be written to, for example, the shared memory 205; and are each connected to the other CPU through a snoop controller 208.

The caches in the CPUs each include a flag for pre-loading. When the flag is set to be “ON”, a parallel pre-loader described later starts pre-loading of the application. During the execution of the parallel pre-loader, programs of other applications are in a state of awaiting execution. The snoop controller 208 has a function of, when data shared between the caches is updated in either of the caches, detecting the updating and updating the data in the other caches. The MMUs (the MMUs 230 and 231) in the CPUs each execute conversion of a logical address into a physical address and management of an available area list of the available areas concerning the areas of a RAM 211.

The CPU #0 is a master CPU, supervises the control of the entire multi-core processor system 200, and executes an OS 220. The OS 220 is a master OS and executes threads assigned to the CPU #0. The OS 220 includes a scheduler, which has a function of controlling to which CPU of the multi-core processor, an application for which a start-up instruction has been received is to be assigned. The scheduler also has a function of controlling the execution order of applications assigned to the CPU #0.

The CPU #1 is a slave CPU and executes an OS 221. The OS 221 is a slave OS and executes threads assigned to the CPU #1. The OS 221 includes a scheduler and the scheduler has a function of controlling the execution order of applications assigned to the CPU #1.

The display 201 displays, for example, data such as text, images, functional information, etc., in addition to a cursor, icons, and/or tool boxes. The display 201 may be a touch panel having keys for entering numerals, various instructions, etc. and may be used for data input. A thin-film-transistor (TFT) liquid crystal display and the like may be employed as the display 201. The keyboard 202 has keys for entering numerals, various instructions, etc. and is used for data input. Further the keyboard 202 may be a touch panel type input pad, a numeric keypad, etc.

The I/F 203 is connected to a network such as a local area network (LAN), a wide area network (WAN), and the Internet through a communication line and is connected to other apparatuses through the network. The I/F 203 administers an internal interface with the network and controls the input and output of data with respect to external apparatuses. For example, a modem or a LAN adaptor may be employed as the I/F 203. In the embodiment, although the program of the application is pre-loaded from flash read-only memory (ROM) 213 to random access memory (RAM) 211 described hereinafter, configuration may be such that the program is pre-loaded from a network such as the Internet via the I/F, to the RAM 211.

The shared memory 205 is memory shared between the CPUs #0 and #1 and includes, for example, the RAM 211, ROM 212, flash ROMs 213 and 215, and a flash ROM controller 214. The arbiter 204 coordinates access requests that are for the shared memory 205 and from the CPUs.

The ROM 212 stores programs such as a boot program. The RAM 211 is used as a work area of the CPUs. The flash ROM 213 stores system software such as the OSs 220 and 221 and programs such as an application. The speed of access of the RAM 211 by the CPUs is higher than that of the flash ROM 213. Each of the OSs loads a program of an application from the flash ROM 213 to the RAM 211 and thereby, the context information of the application is expanded on the RAM 211.

The flash ROM controller 214, under the control of the CPUs, controls the reading and writing of data with respect to the flash ROM 215. The flash ROM 215 stores the data written thereto under the control of the flash ROM controller 214. An example of the data is image data, moving picture data, etc. acquired by the user of the multi-core processor system 500, via the I/F 508. A memory card, SD card, etc. may be adopted as the flash ROM 215, for example.

The clock supply circuit 207 supplies a clock to components such as the CPUs. In the embodiment, the clock supply circuit 207 is assumed to supply clocks of a frequency of 100 or 200 [MHz]. The clock supply circuit 207 includes the registers 209 and 210. The register 209 can set the frequency of the clock to be supplied to the CPU #0 and the register 210 can set the frequency of the clock to be supplied to the CPU #1.

When the value indicated by the register 209 is “0”, the frequency of the clock supplied to the CPU #0 is 100 [MHz] and, when the value indicated by the register 209 is “1”, the frequency of the clock supplied to the CPU #0 is 200 [MHz]. When the value indicated by the register 210 is “0”, the frequency of the clock supplied to the CPU #1 is 100 [MHz] and, when the value indicated by the register 210 is “1”, the frequency of the clock supplied to the CPU #1 is 200 [MHz]. In the embodiment, the frequency of the clock that is supplied to the CPUs during the pre-loading of an application is set to be 200 [MHz]; and the frequency of the clock that is supplied to the CPUs during the ordinary execution of an application is set to be 100 [MHz].

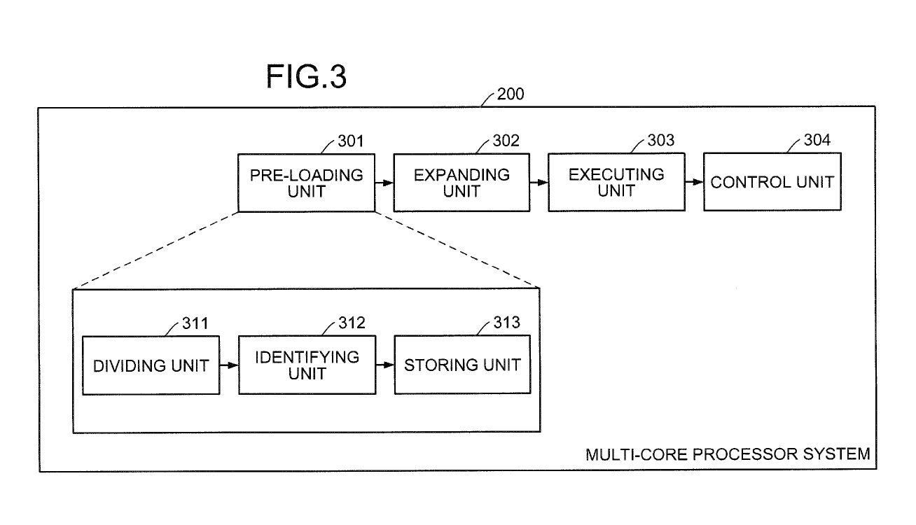

FIG. 3 is a block diagram of a functional configuration of the multi-core processor system 200. The multi-core processor system 200 includes a pre-loading unit 301, an expanding unit 302, an executing unit 303, and a control unit 304. For example, programs including functions of the pre-loading unit 301 to the control unit 304 are stored in the storage such as the flash ROM 213; the CPU #0 or #1 accesses the storage and reads the programs; the CPU #0 or #1 executes processing the programs; and thereby, processes of the functional units from the pre-loading unit 301 to the control unit 304 are executed.

The pre-loading unit 301 pre-loads the program of the application to be executed onto plural fragment areas of the RAM 211. The “fragment areas” refer to available areas that are among the available areas of the RAM 211 and can store data of a size smaller than or equal to a predetermined size. In the embodiment, the smallest size (Min(application size)) among the sizes of the applications is (Min(application size))≧the predetermined size. The pre-loading unit 301 starts the pre-loading when a predetermined relation is satisfied by an estimated period elapsing until the time at which the program of the application to be executed is executed and the time period necessary for the pre-loading of the program of the application to be executed. The pre-loading unit 301 may pre-load the program of the application when the processor is not executing another application.

The pre-loading unit 301 includes a dividing unit 311, an identifying unit 312, and a storing unit 313. The dividing unit 311 divides into code, the program of the application to be executed that is stored in the storage such as the flash ROM 213. From among the group of available areas of the RAM 211 whose access speed is higher than that of the flash ROM 213, the identifying unit 312 identifies two or more available areas whose total size is greater than the size of the program of the application to be executed. The storing unit 313 distributes and stores to the two or more available areas identified by the identifying unit 312, the code resulting from the division by the dividing unit 311.

The control unit 304 sets the frequency of the operation clock that is used when the program of the application to be executed is pre-loaded, to be higher than the frequency of the operation clock that is used when the program is executed.

The expanding unit 302 concatenates the program of the application, stored in the plural fragment areas and expands the concatenated program in the area of the RAM 211. The executing unit 303 executes the program of the application based on the context information of the application, acquired by the expansion. When the fragment areas store a portion of the program of the application, the expanding unit 302 pre-loads the program exclusive of the portion stored in the fragment areas. The expanding unit 302 concatenates the pre-loaded program and the portion stored in the fragment areas, and expands the concatenated program in the area of the RAM 211.

The executing unit 303 executes the program of the application using the context expanded by the expanding unit 302.

Description will be made in detail using first and second examples. The first example represents an example where, when a program of an app #B is pre-loaded and a start-up instruction for the app #B is received, the partial code pre-loaded in the fragment areas is concatenated and thereby, the context information of the app #B is produced. The second example represents an example where, when a portion of the program of the app #B is pre-loaded in the fragment areas, the remaining code of the program of the app #B are loaded, and the pre-loaded code and the rest of the code are concatenated with each other to produce the context information of the app #B.

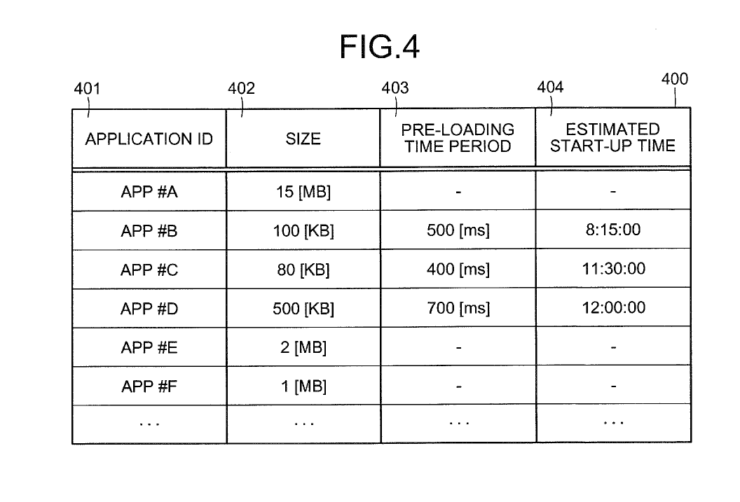

FIG. 4 is an explanatory diagram of an example of a trigger table. A trigger table 400 includes a field 401 for the ID of an application, a field 402 for the size, a field 403 for the pre-loading time period, and a field 404 for the estimated start-up time. The application ID field 401 stores the identification information of the application. The size field 402 indicates the size of the application whose identification information is indicated in the application ID field 401.

The pre-loading time period field 403 indicates the pre-loading time period that is necessary for pre-loading the program of the application whose identification information is indicated in the application ID field 401. As to the pre-loading time period, the design engineer of the application may measure the time period using an electronic system level (ESL) tool, etc., or the OS 220 may measure the pre-loading time period for plural times and may accordingly update the pre-loading time period. The estimated start-up time field 404 indicates the estimated start-up time of the application whose identification information is indicated in the application ID field 401. The estimation of the start-up time of an application is known (see, for example, Japanese Laid-Open Patent Publication No. 2005-275707) and therefore, will not again be described in detail.

Taking the app #B as an example, the size of the app #B is 100 [KB]; the pre-loading time period is 500 [ms]; and the estimated start-up time is 8:15:00. When the starting up of the pre-loading is 500 [ms] before the 8:15:00, the pre-loading of the app #B is completed by the estimated start-up time. In this case, Min(application size) is the size of the app #C and therefore, the fragment areas are available areas among the group of available areas and whose sizes each are smaller than or equal to 80 [KB].

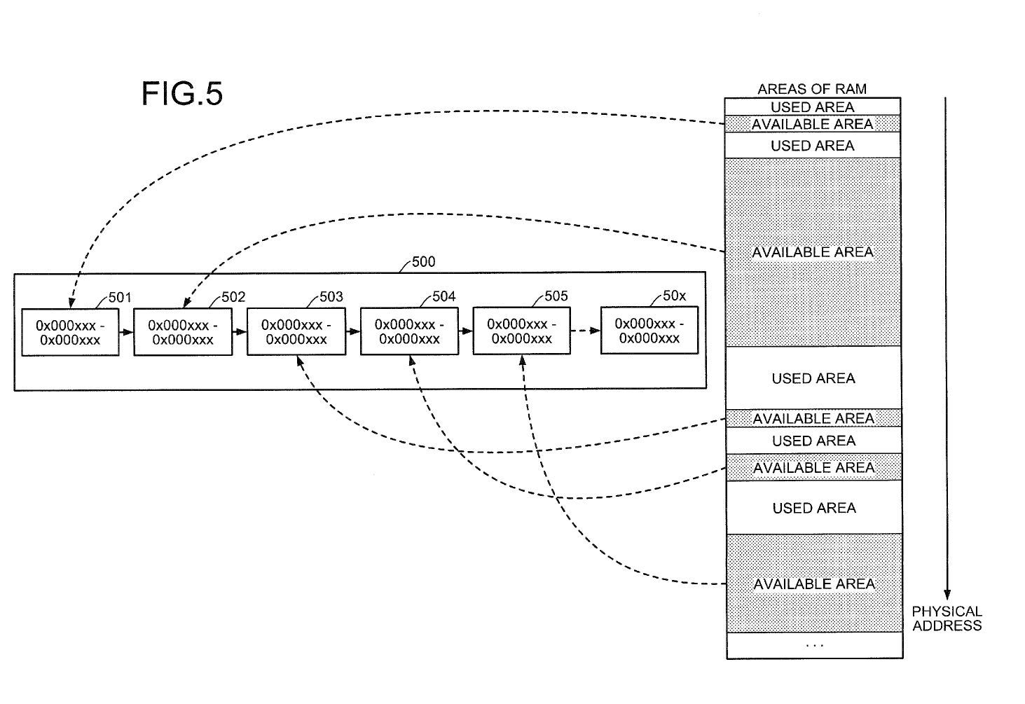

FIG. 5 is an explanatory diagram of an example of the available areas of the RAM 211. FIG. 5 depicts the areas of the RAM 211 and an available area list 500. As to the areas of the RAM 211, used areas and the available areas are depicted. The available area list 500 includes nodes 501 to 50x each including as data information concerning physical addresses of the available areas among the areas of the RAM 211. In the available area list 500, the nodes are connected with each other in ascending value of the physical address.

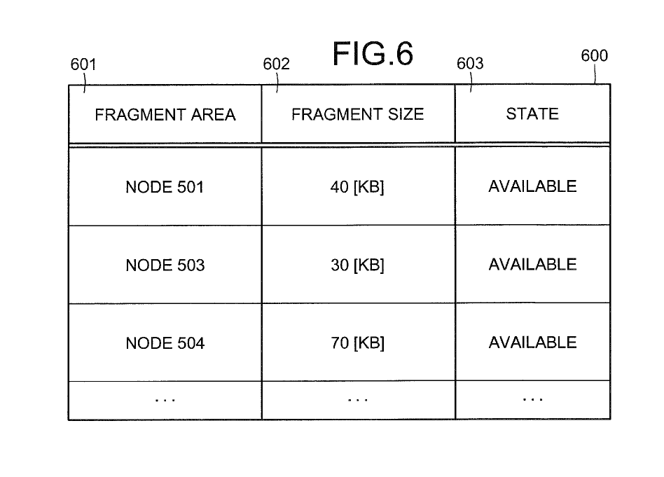

FIG. 6 is an explanatory diagram of an example of a fragment area management table. The fragment area management table 600 includes a field 601 for a fragment area, a field 602 for the fragment size thereof, and a field 603 for the state thereof. The fragment area field 601 stores the node number of the fragment area whose size is smaller than or equal to the predetermined size, among the available areas depicted in FIG. 5. It is assumed that the node number registered in the fragment area field 601 and the node number in the available area list 500 are correlated with each other. The fragment size field 602 indicates the size of the data that can be stored in the fragment area whose node number is indicated in the fragment area field 601.

The state field 603 indicates “in use” when the pre-loaded data is stored in the fragment area whose address is registered in the fragment area field 601; and indicates “available” when no pre-loaded data is stored in the indicated fragment area. In the example, no fragment area is used according to the fragment area management table 600 and therefore, “available” is registered in each of the state fields 603.

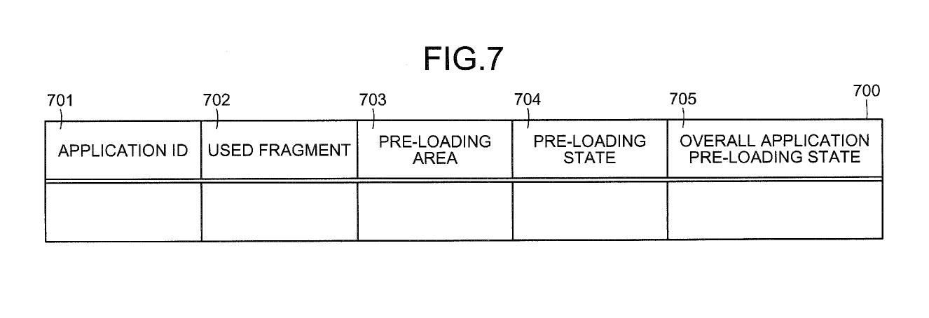

FIG. 7 is an explanatory diagram of an example of a pre-loaded app management table. The pre-loaded app management table 700 includes a field 701 for the ID of an application, a field 702 for a used fragment, a field 703 for an area for the pre-loading, a field 704 for the state of the pre-loading, and a field 705 for the state of pre-loading of the entire application. The application ID field 701 stores identification information of an application that is pre-loaded. It is assumed that the identification information registered in the application ID field 701 and the identification information registered in the application ID field 401 are correlated with each other. The used fragment field 702 stores the node number of the fragment area that is the pre-loading area. It is assumed that the node number registered in the used fragment field 702 and the node number registered in the fragment area field 601 in the fragment area management table 600 are correlated with each other.

The pre-loading area field 703 stores the logical address of the partial code that is stored in the fragment area represented by the node indicated in the used fragment field 702, the partial code being of the program of the application whose identification information is indicated in the application ID field 701. The pre-loading state field 704 indicates “completed” or “uncompleted” concerning the process of storing the partial code to the fragment areas. In the embodiment, “completed” is indicated in the pre-loading state field 704 after the partial code is stored to the fragment areas; and when information related to the execution of the currently executed application is registered in the fragment areas, the partial code therein is deleted and therefore, “uncompleted” is registered in the pre-loading state field 704. The overall application pre-loading state field 705 indicates “completed” or “uncompleted” concerning the process of storing the entire application into the fragment areas. In the embodiment: “completed” is indicated in the overall application pre-loading state field 705 after the entire application is stored in the fragment areas; and when the information related to the execution of the currently executed application is registered in the fragment areas, the partial code therein are deleted and therefore, “uncompleted” is registered in the overall application pre-loading state field 705.

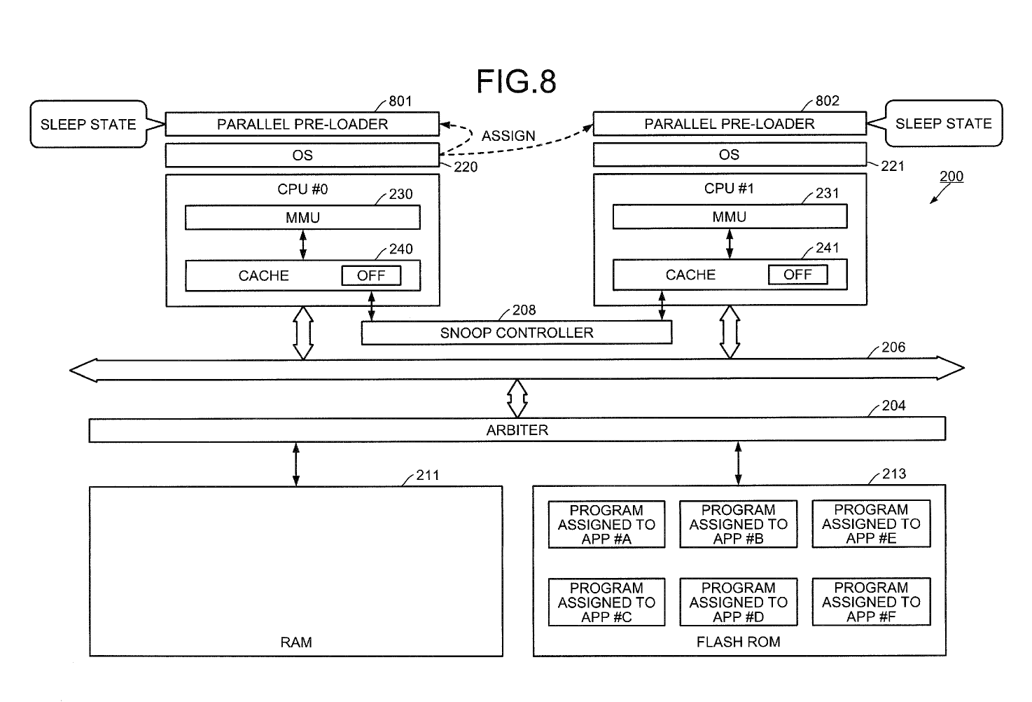

FIG. 8 is an explanatory diagram of an example of assignment of parallel pre-loaders. The parallel pre-loaders each have a function of pre-loading the program of an application. The OS 220 assigns the parallel pre-loaders 801 and 802 to the CPUs. The OSs each set the parallel pre-loader assigned thereto to be in a sleep state.

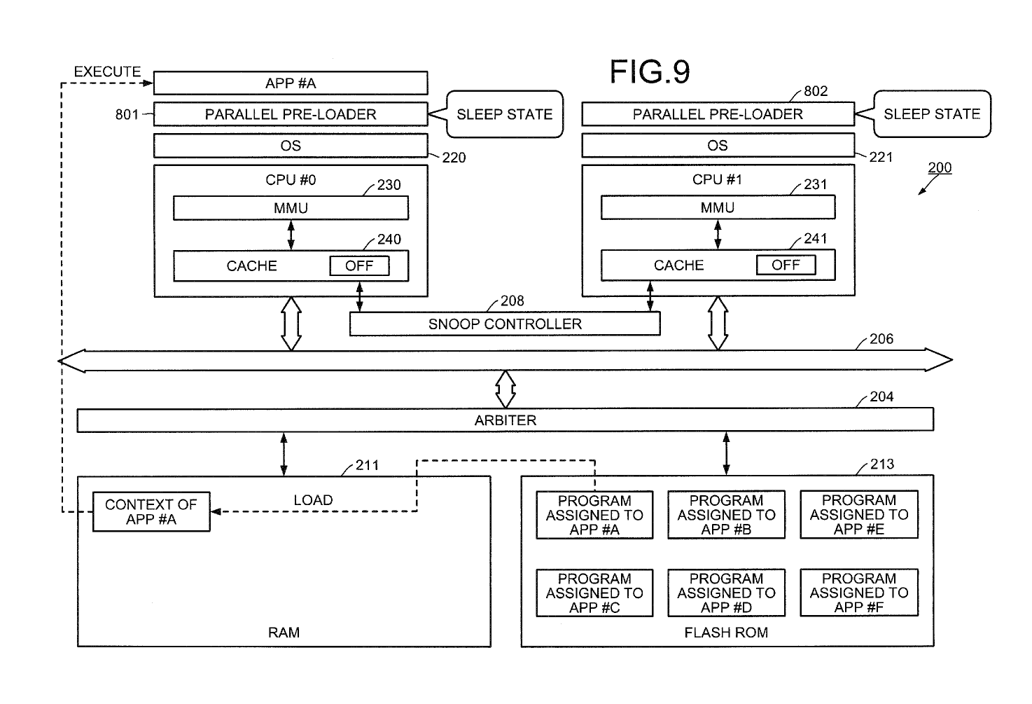

FIG. 9 is an explanatory diagram of an example of execution of an app #A. When the OS 220 receives a start-up instruction for the app #A, the OS 220 determines whether the identification information of the app #A is registered in the application ID field 701 of the pre-loaded app management table 700. As depicted in FIG. 7, the identification information of the app #A is not registered in the application ID field 701 of the pre-loaded app management table 700. The OS 220 loads the program of the app #A from the flash ROM 213 to the RAM 211 and thereby, produces the context information of the app #A. The OS 220 determines that the assignment destination of the app #A is the CPU #0 and executes the app #A using the context of the app #A produced thereby.

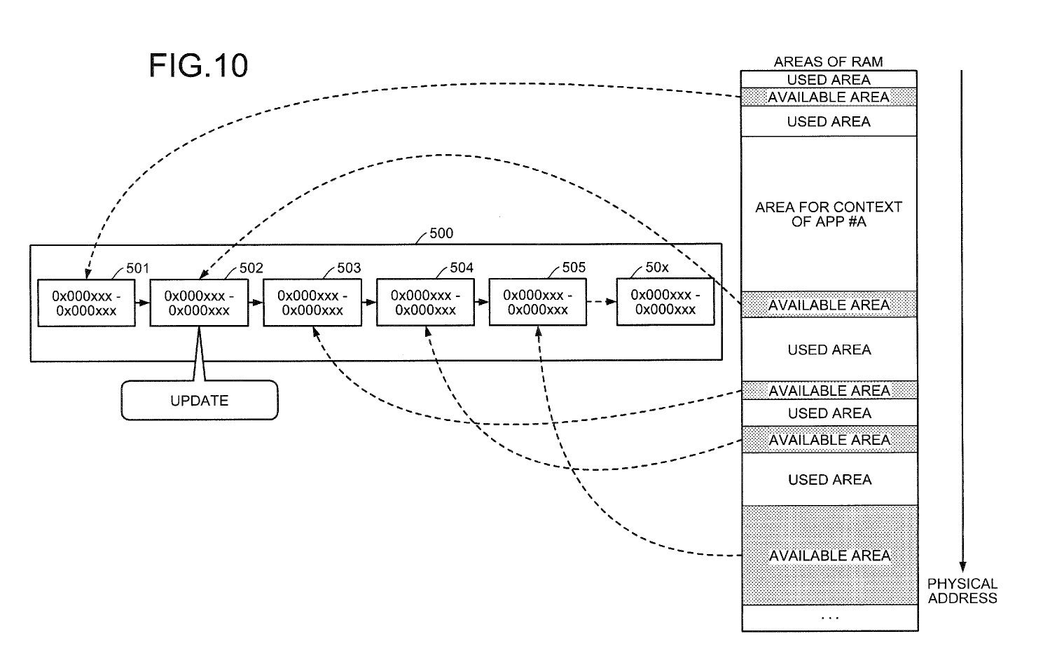

FIG. 10 is an explanatory diagram of the available areas of the RAM 211 after the execution of the app #A. Among the areas of the RAM 211, the available areas change because the areas for the context of the app #A are added thereto and therefore, the MMU 230 updates the available area list 500. The OS 220 identifies the updated node 502 from the available area list 500; determines whether the size of the available area represented by the physical address that is the data of the identified node 502 is smaller than or equal to the predetermined size; and identifies the available area represented by the node 502 as the fragment area.

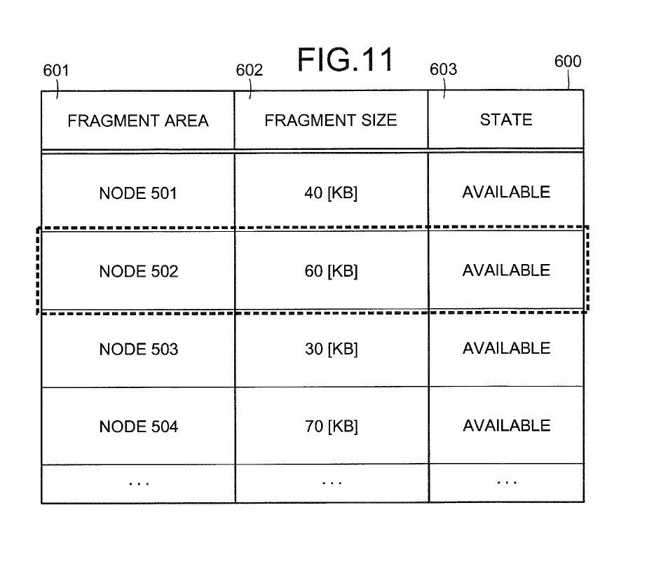

FIG. 11 is an explanatory diagram of an example of the updating of the fragment area management table 600 executed in association with a change of the available areas. The OS 220 registers the identified node 502, the size of the fragment area represented by the identified node 502, and the state of the fragment area into the fragment area management table 600. The fragment area management table 600 depicted in FIG. 11 is the fragment area management table 600 resulting after the addition of the information concerning the node 502.

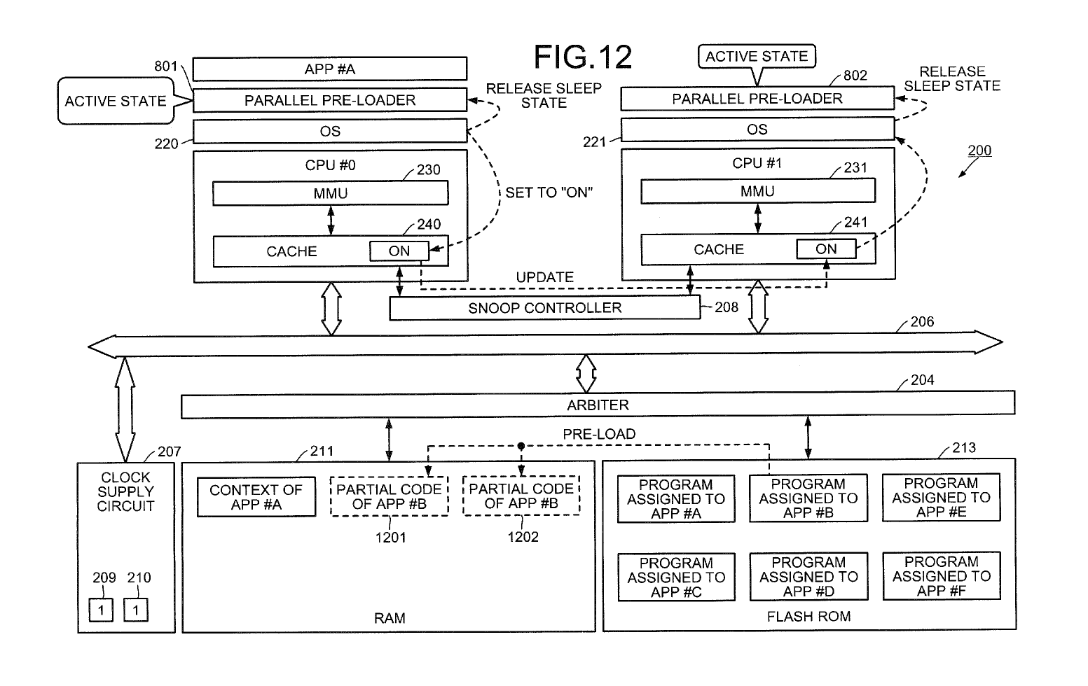

FIG. 12 is an explanatory diagram of an example of the pre-loading of the app #B. The OS 220 triggers the pre-loading of the app #B when a time point arrives that is obtained by subtracting the pre-loading time period of the app #B from the start-up time of the app #B based on the trigger table 400. It is assumed for the time that the OS 220 executes a software timer and thereby, counts the time. The OS 220 registers the identification information of the app #B into the application ID field 701 of the pre-loaded app management table 700 and sets “uncompleted” in the pre-loading state field 704. The OS 220 sets the flag in the cache 240 to be “ON” and releases the sleep state of the parallel pre-loader 801. When the snoop controller 208 detects the change of the flag in the cache, the snoop controller 208 sets the flag in the cache 241 to “ON”.

When the flag in the cache 241 is set to “ON”, the OS 221 releases the sleep state of the parallel pre-loader 802. The parallel pre-loader 801 or 802 identifies the application for which “uncompleted” is registered in the overall application pre-loading state field 705 of the pre-loaded app management table 700; sets the value of the register 209 or 210 to be “1” because “uncompleted” is set in the overall application pre-loading state field 705 for the app #B; and identifies the size of the app #B based on the size field 402 of the trigger table 400.

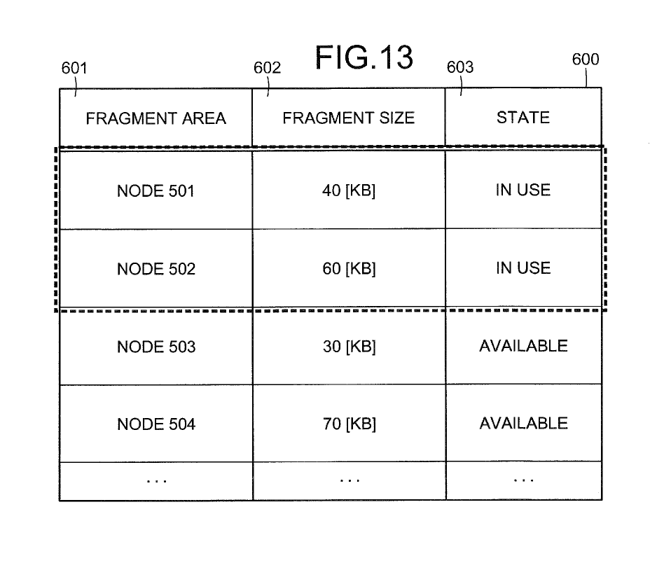

FIG. 13 is an explanatory diagram of an example of securing of the pre-loading destination of the app #B. The parallel pre-loader 801 or 802 secures the fragment areas whose total size corresponds to the size of the app #B based on the size field for each of the fragment areas in the fragment area management table 600. It is assumed in the example that the fragment areas represented by the nodes 501 and 502 are secured as the areas to be the pre-loading area of the app #B. The parallel pre-loader 801 or 802 updates the state field 603 concerning each of the nodes 501 and 502 in the fragment area management table 600 to set “in use” in the respective state fields 603.

The parallel pre-loader 801 or 802 registers the addresses of the secured fragment areas into the pre-loaded app management table 700; and registers the logical addresses of the partial code of the program of the app #B to be stored in the secured fragment areas, into the pre-loading area field 703 of the pre-loaded app management table 700.

The parallel pre-loaders 801 and 802 store the partial code from the flash ROM 213 to the fragment areas. For example, the parallel pre-loader 801 stores a partial code 1201 of the app #B into the RAM 211 and the parallel pre-loader 802 stores a partial code 1202 of the app #B into the RAM 211. When the pre-loaders each complete the pre-loading for the pre-loaded area field 703 of the pre-loaded app management table 700, the pre-loaders each change the pre-loading state field 704 and set “completed” therein. When the pre-loading of the app #B is completed, the parallel pre-loaders 801 and 802 each change the overall application pre-loading state field 705 and set “completed” therein.

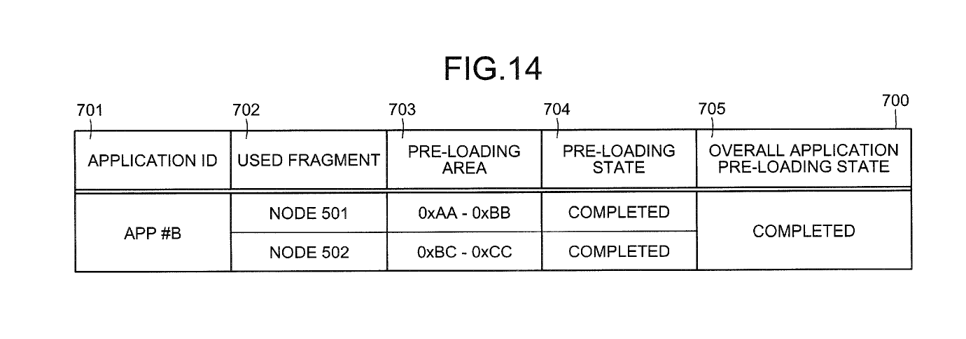

FIG. 14 is an explanatory diagram of an example of the updating of the pre-loaded app management table 700. In the pre-loaded app management table 700 of FIG. 14, the used fragment field 702 concerning the app #B indicates nodes 501 and 502; and the pre-loading area field 703 concerning the app #B indicates “0xAA to 0xBB” and “0xBC to 0xCC”. The pre-loading state field 704 and the overall application pre-loading state field 705 concerning the app #B of the pre-loaded app management table 700 of FIG. 14 both indicate “completed”.

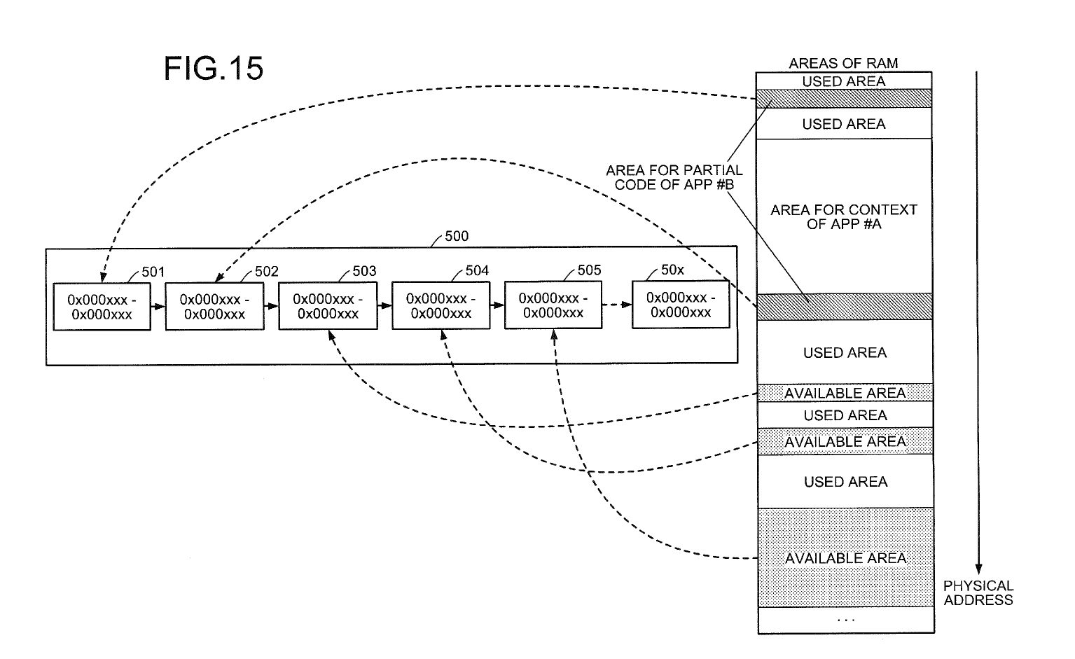

FIG. 15 is an explanatory diagram of an example of the areas of the RAM 211 after the app #B is pre-loaded. Among the areas of the RAM 211, areas for the partial code of the app #B are present at two positions. The app #B is not executed at the time when the app #B is pre-loaded and therefore, the available area list 500 is not updated. Although the RAM 211 stores the partial code of the app #B, other applications can store information concerning the other applications to the area storing the partial code of the app #B.

When “completed” is set in the overall application pre-loading state field 705 for each of the applications of the pre-loaded app management table 700, the parallel pre-loaders 801 and 802 each sets the values of the registers 209 and 210 to each be “0”; each sets the start-up flag to be “OFF”; and transitions to the sleep state.

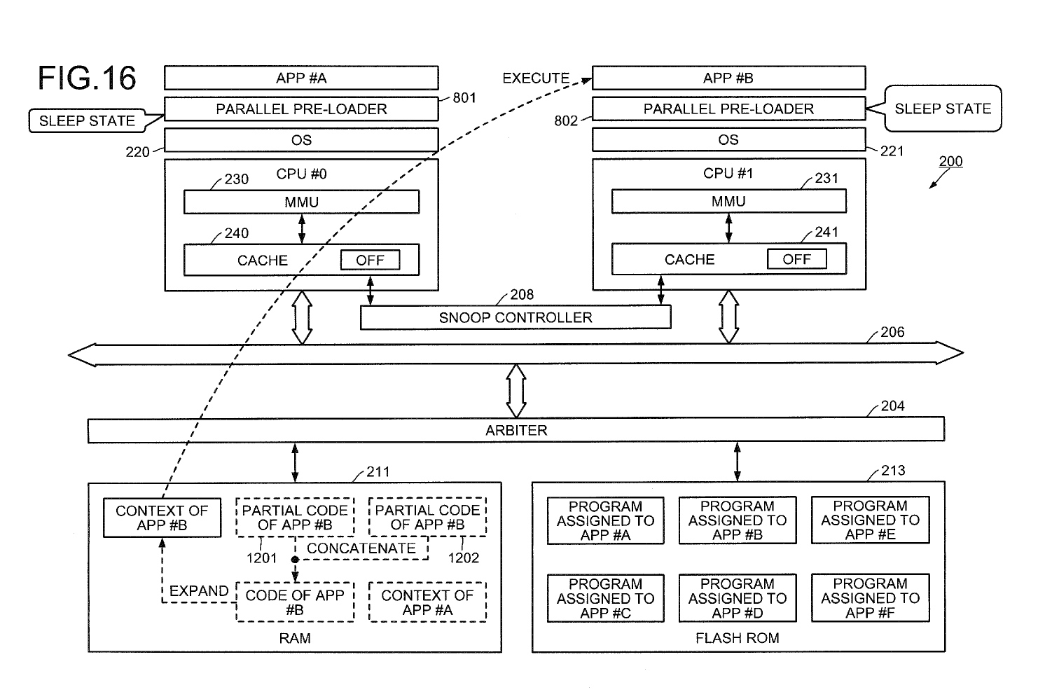

FIG. 16 is an explanatory diagram of the execution of the app #B. When the OS 220 receives a start-up instruction for the app #B, the OS 220 concatenates the partial code 1201 and 1202 of the app #B and thereby, produces the code of the app #B. As to the concatenating, the partial code is concatenated in order of the logical addresses described in the pre-loading area of the pre-loaded app management table 700. The OS 220 expands the produced code of the app #B and thereby, produces the context of the app #B. The process of expanding from the code of the app #B to the context thereof is same as the conventional process of expanding to the context and therefore, will not again be described in detail. The OS 220 assigns the app #B to the CPU #1 and the OS 221 executes the app #B.

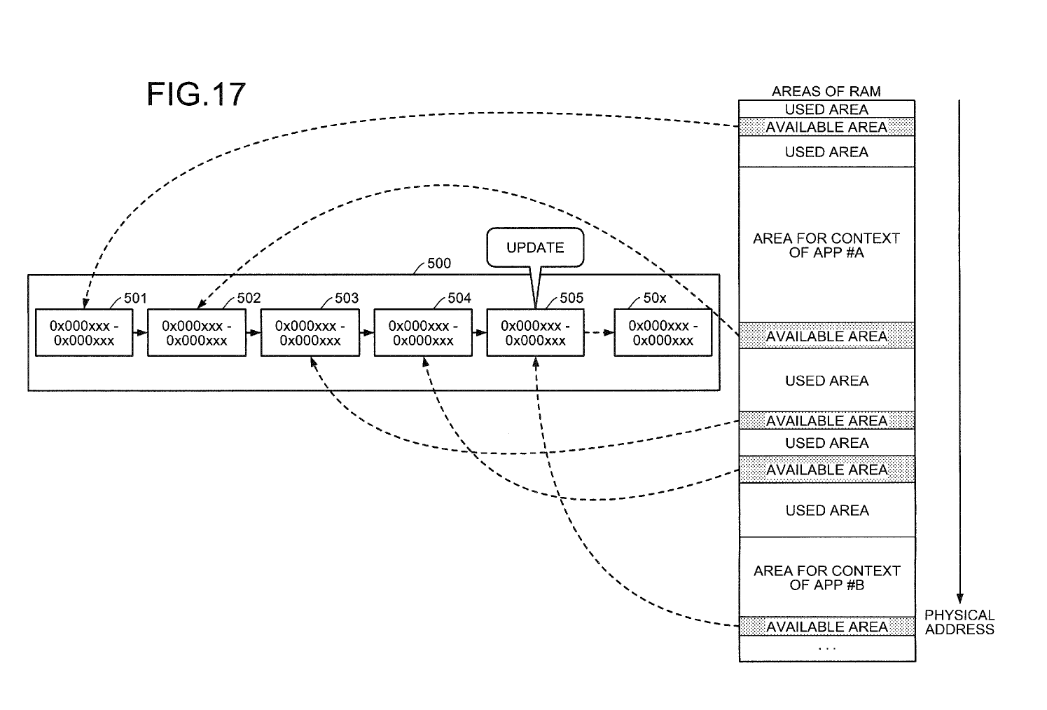

FIG. 17 is an explanatory diagram of the areas of the RAM 211 after the production of the context of the app #B in the first example. Among the areas of RAM 211, the areas for the context of the app #B are present while the areas for the partial code of the app #B are not present. The context of the app #B is produced and therefore, the MMU 230 updates the address of the node 505 in the available area list 500.

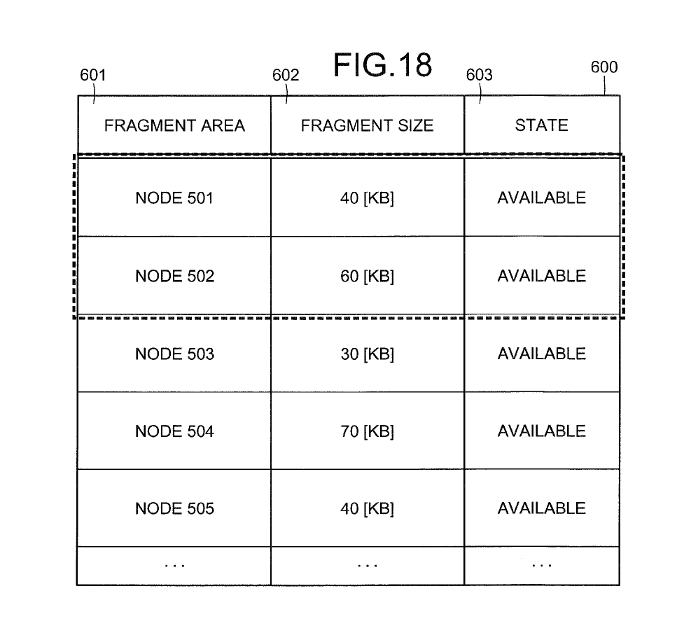

FIG. 18 is an explanatory diagram of the fragment area management table 600 after the context of the app #B is produced in the first example. The OS 220 updates the state field 603 concerning the nodes 501 and 502 and sets “available” therein. When the available area list 500 is updated, the OS 220 identifies the node 505 whose address is updated in the available area list 500 and determines if the size of the available area represented by the node 505 is smaller than or equal to the predetermined size, based on the data on the identified node 505. In this example, the OS 220 determines that the size of the available area represented by the node 505 is smaller than or equal to the predetermined size and thus, the available area represented by the node 505 is identified as the fragment area. The OS 220 adds the information concerning the newly identified node 505 to the fragment area management table 600.

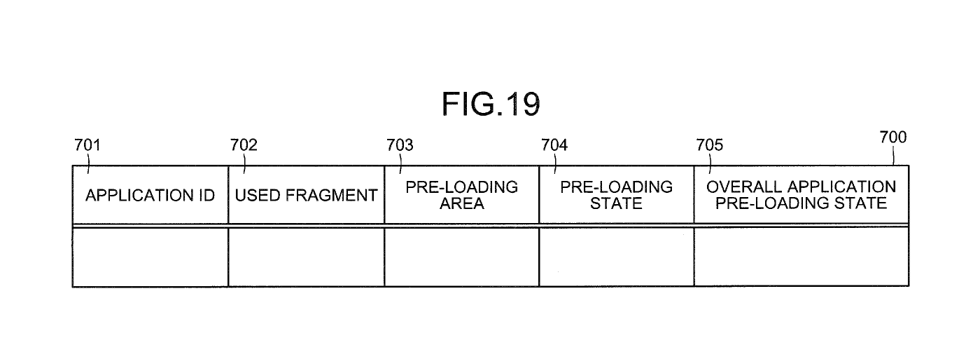

FIG. 19 is an explanatory diagram of an example of updating of the pre-loaded app management table 700. Because the app #B is started up, the OS 220 deletes the information concerning the app #B from the pre-loaded app management table 700.

In the second example, the case will be described where any one of the fragment areas to which the app #B is pre-loaded is used for a process of another application. In the second example, operations up to the pre-loading of the app #B are same as those in the first example (FIGS. 4 to 15) and therefore, the process steps taken after the pre-loading will be described.

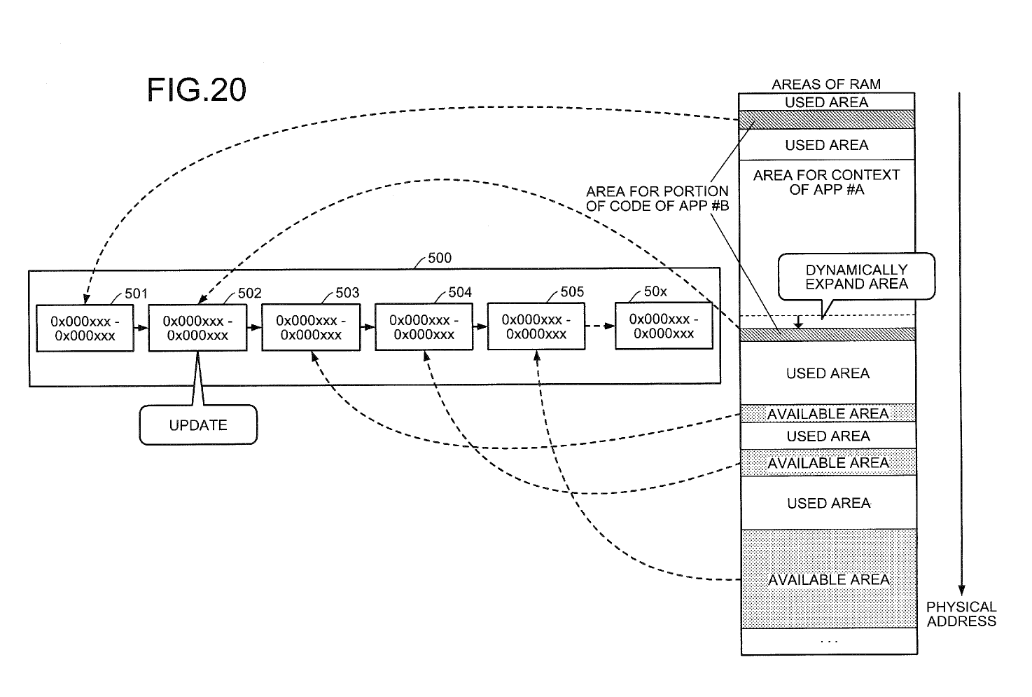

FIG. 20 is an explanatory diagram of an example where the areas for the context of the app #A are dynamically increased. When data to be stored during the execution of the app #A increases, etc., the app #A dynamically secures areas for the context of the app #A. To efficiently access the RAM 211, it is advantageous to secure consecutive areas and therefore, the app #A dynamically increases the areas for the context of the app #A. The fragment areas storing the partial code of the app #B are changed to the areas for the context of the app #A and therefore, the MMU 230 updates the data of the nodes in the available area list 500.

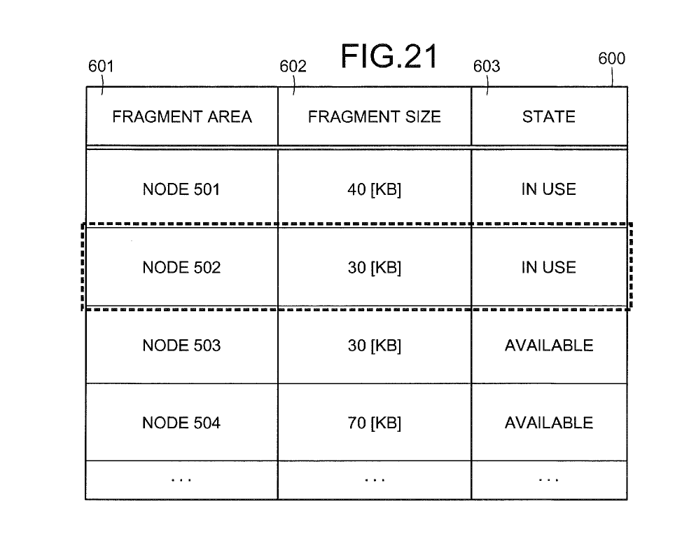

FIG. 21 is an explanatory diagram of an example of the updating of the fragment area management table 600. The OS 220 identifies the node whose data has been updated in the available area list 500; determines if the size of the area indicated by the data of the identified node 502 is smaller than or equal to the predetermined size; and thus, determines whether the area indicated by the data of the identified node 502 is a fragment area.

If the OS 220 determines that the area indicated by the data of the identified node 502 is the fragment area, the OS 220 searches for the identified node 502, based on the node number registered in the fragment area field 601 of the fragment area management table 600. The OS 220 updates the fragment size field 602 concerning the node number that is retrieved and sets in the fragment size field 602, the size of the fragment area represented by the identified node 502.

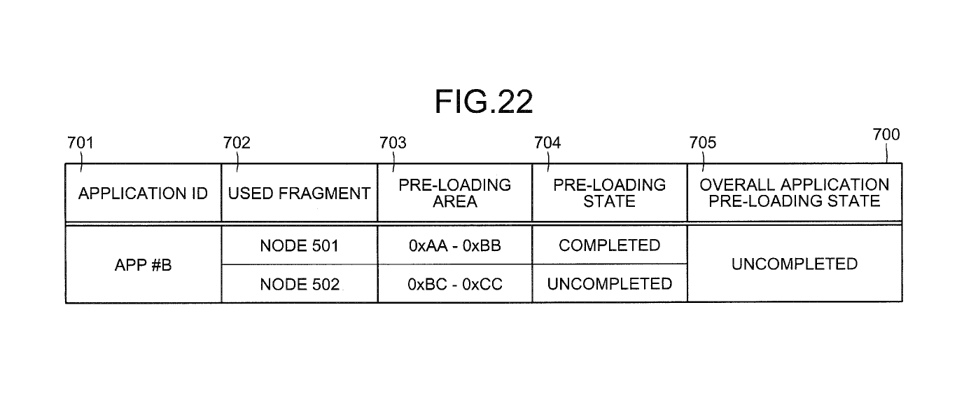

FIG. 22 is an explanatory diagram of an example of the updating of the pre-loaded app management table 700. The updated state of the node 502 is the “in use” state and the fragment area represented by the updated node 502 is deleted and therefore, the OS 220 updates the pre-loading state field 704 concerning the node 502 and sets therein “uncompleted” in the pre-loaded app management table 700 and also updates the overall application pre-loading state field 705 and sets therein “uncompleted”.

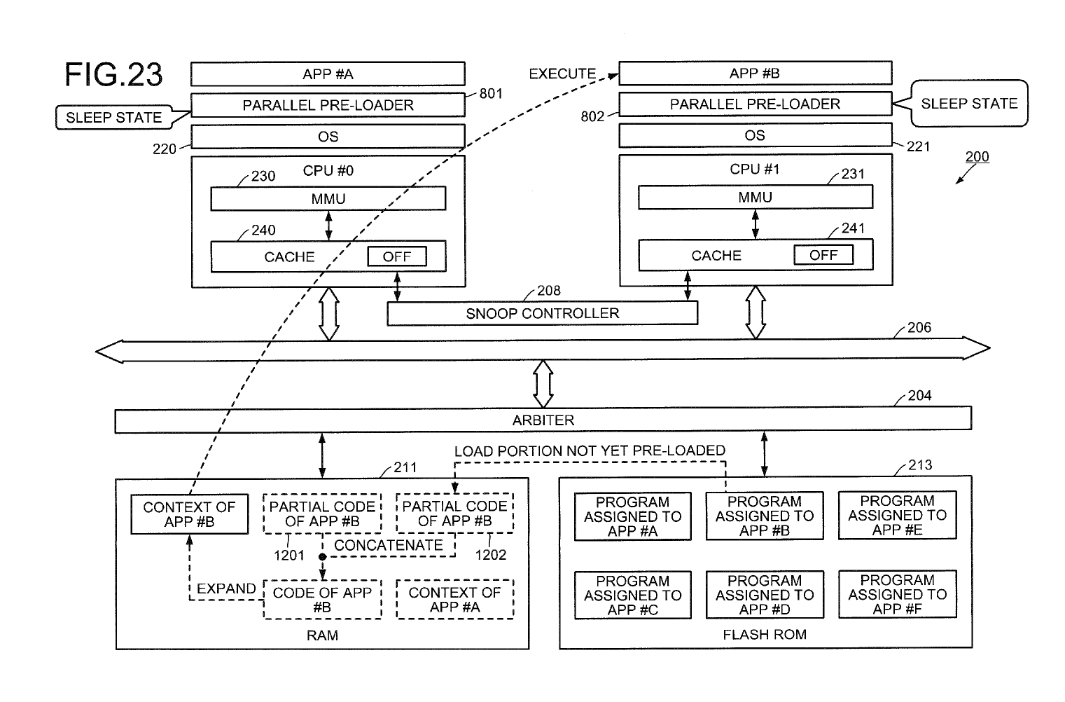

FIG. 23 is an explanatory diagram of the execution of the app #B. When the OS 220 receives a start-up instruction for the app #B, the OS 220 refers to the pre-loaded app management table 700. The overall application pre-loading state field 705 indicates “uncompleted” and therefore, the OS 220 identifies the partial code of the app #B, for which the pre-loading state field 704 indicates “uncompleted”. The pre-loading of the partial code whose logical address is “0xBC to 0xCC” is still uncompleted and therefore, the OS 220 loads the partial code of the app #B onto the RAM 211 and concatenates the loaded partial code of the app #B and the pre-loaded partial code thereof to produce the context of the app #B. When the OS 220 determines that the assignment area of the app #B is the CPU #1, the OS 220 assigns the app #B to the CPU #1 and the OS 221 executes the app #B.

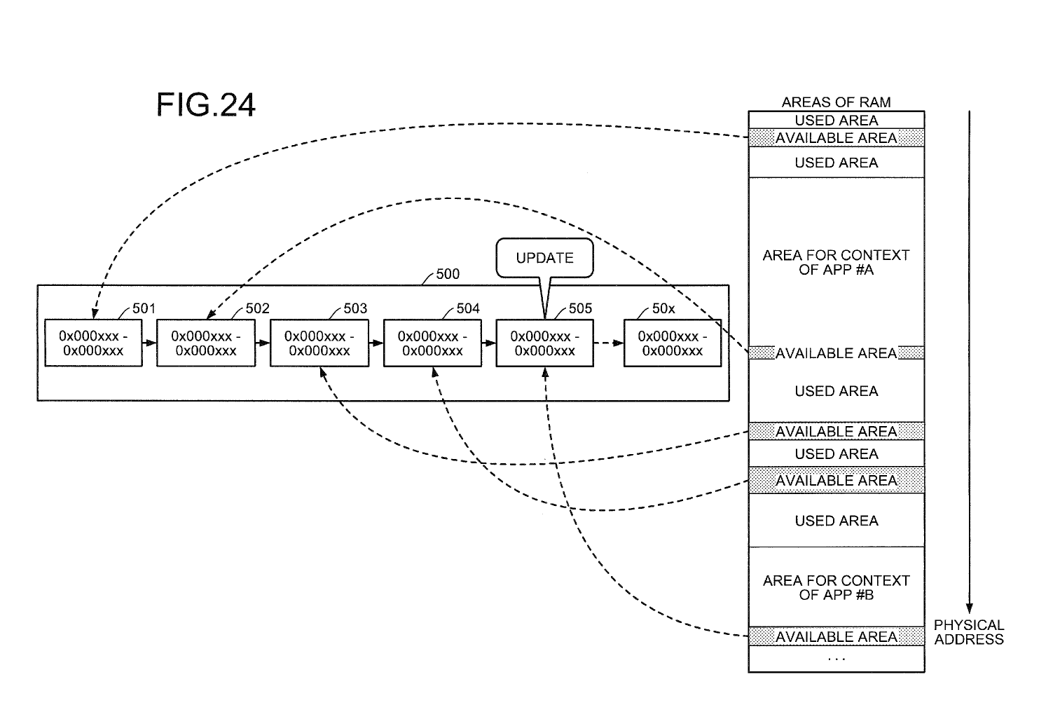

FIG. 24 is an explanatory diagram of the areas of the RAM 211 after the context of the app #B is produced in the second example. Among the areas of the RAM 211, the areas for the context of the app #B are present while the areas for the partial code thereof are not present. The context of the app #B is produced and therefore, the MMU 230 updates the data of the node in the available area list 500.

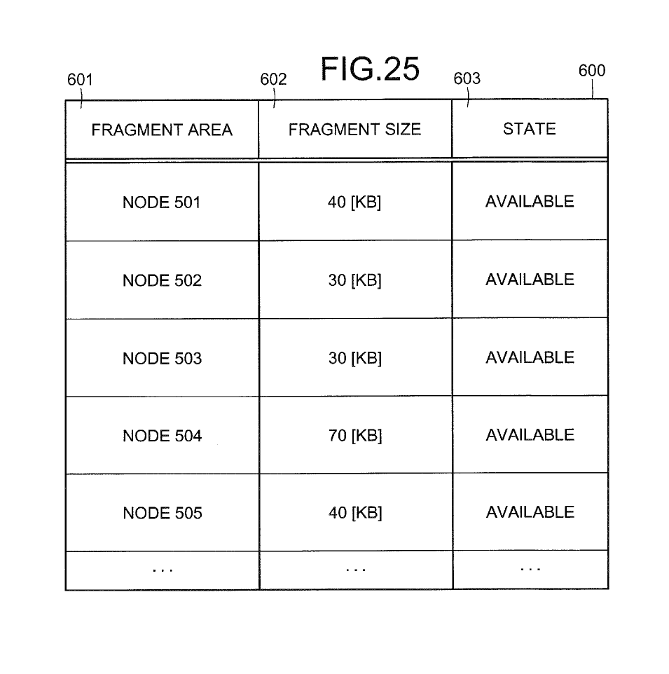

FIG. 25 is an explanatory diagram of the fragment area management table 600 after the context of the app #B is generated in the second example. The OS 220 updates the state fields 603 concerning the node numbers 501 and 502 and sets therein each “uncompleted”. When the available area list 500 is updated, the OS 220 determines whether the size of the available areas represented by the nodes are each smaller than or equal to the predetermined size, based on the data on the nodes whose data is changed in the available area list 500 and thereby, identifies new fragment areas. In this case, the OS 220 determines that the size of the available area represented by the node 505 is smaller than or equal to the predetermined size, and newly adds the information concerning the node 505 to the fragment area management table 600.

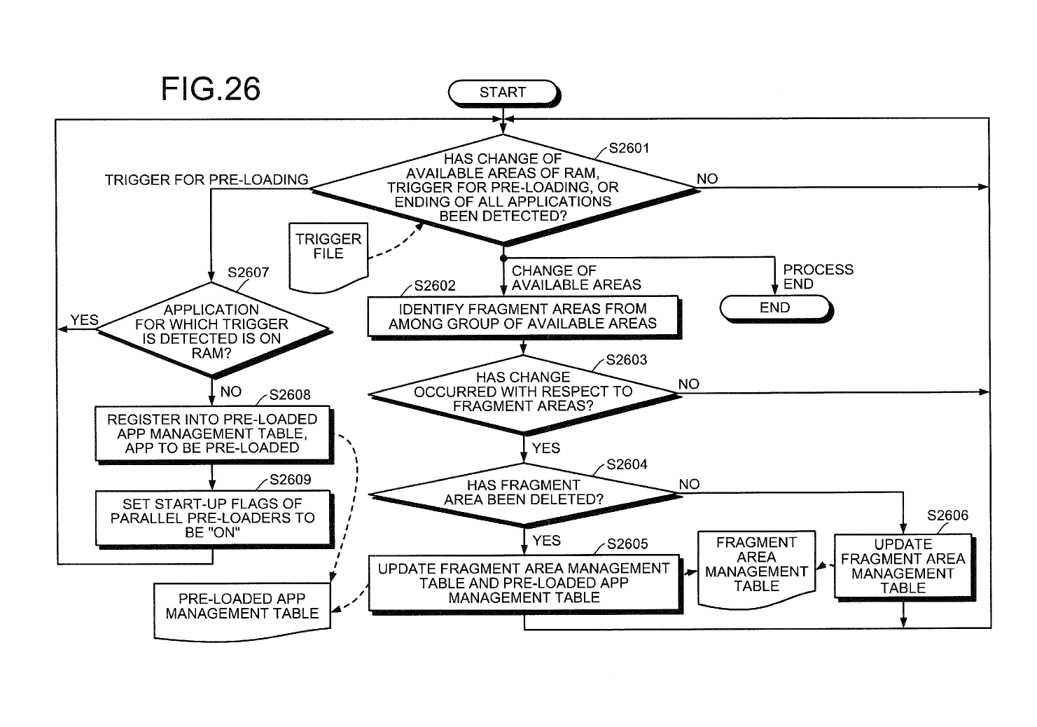

FIG. 26 is a flowchart of an example of a procedure for a loading control process executed by the master OS. The master OS determines whether a change of the available areas of the RAM 211, a trigger for the pre-loading, or the ending of all the applications has been detected (step S2601). If the master OS determines that none among a change of the available areas of the RAM 211, a trigger for pre-loading, and the ending of all the applications has been detected (step S2601: NO), the procedure returns to step S2601. If the master OS determines that a change of the available areas of the RAM 211 has been detected (step S2601: CHANGE OF AVAILABLE AREAS), the master OS identifies the fragment areas from among the group of available areas (step S2602).

The master OS determines whether an change has occurred with respect to the fragment areas (step S2603). If the master OS determines that no change has occurred (step S2603: NO), the procedure returns to step S2601. If the master OS determines that a change has occurred (step S2603: YES), the master OS determines whether a fragment area has been deleted (step S2604).

If the master OS determines that a fragment area has been deleted (step S2604: YES), the master OS updates the fragment area management table 600 and the pre-loaded app management table 700 (step S2605) and the procedure returns to step S2601. If the master OS determines that no fragment area has been deleted (step S2604: NO), the master OS updates the fragment area management table 600 (step S2606) and the procedure returns to step S2601.

If the master OS determines at step S2601 that a trigger for pre-loading has been detected (step S2601: TRIGGER FOR PRE-LOADING), the master OS determines whether the application for which the trigger is detected is on the RAM 211 (step S2607). In the embodiment, the pre-loading of the application to be executed is started in response to the trigger for the pre-loading. However, the pre-loading of the application that is to be executed and that needs to be pre-loaded may be started when no other application is executed. If the master OS determines that the application for which the trigger is detected is on the RAM 211 (step S2607: YES), the procedure returns to step S2601.

If the master OS determines that the application for which the trigger is detected is not on the RAM 211 (step S2607: NO), the app to be pre-loaded is registered into the pre-loaded app management table 700 (step S2608). The master OS sets each of the start-up flags of the parallel pre-loaders to be “ON” (step s2609) and the procedure returns to step S2601. If the master OS determines at step S2601 that the ending of all the applications has been detected (step S2601: PROCESS END), the series of operations comes to an end.

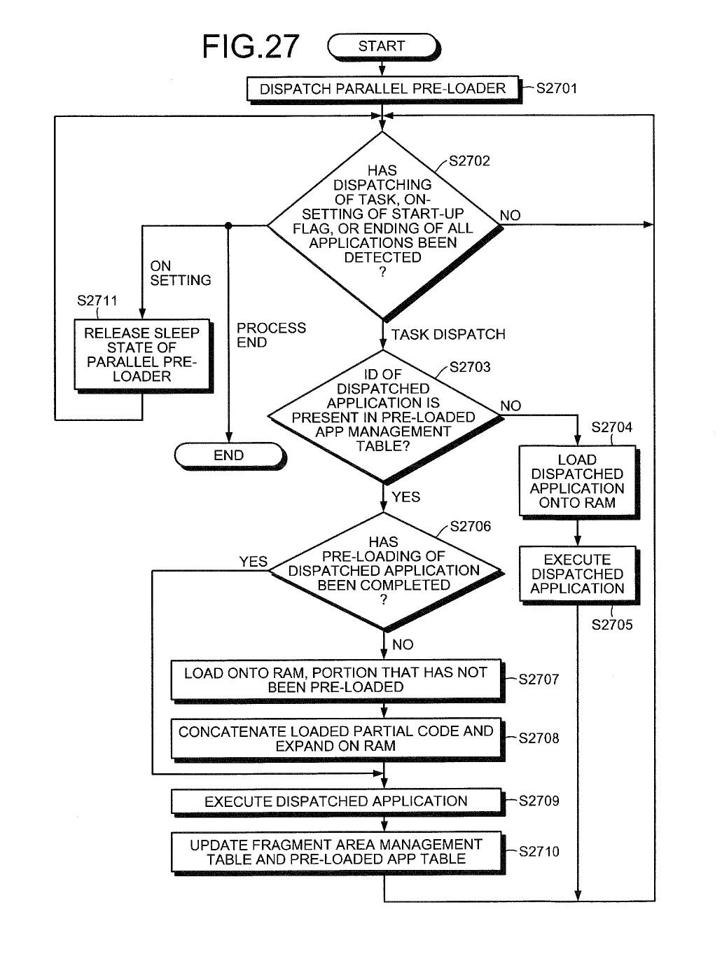

FIG. 27 is a flowchart of an example of a procedure for a loading control process executed by each of the OSs. The operations of the OSs including the master OS and the slave OS will be described. The OS dispatches the parallel pre-loader (step S2701) and determines whether a dispatching of a task, an ON-setting of the start-up flag, or the ending of the processing of all the applications has been detected (step S2702). If the OS determines that none among a dispatching of a task, the ON-setting of the start-up flag, and the ending of the processing of all the applications has been detected (step S2702: NO), the procedure returns to step S2702.

If the OS determines that the dispatching of a task has been detected (step S2702: c), the OS determines whether the ID of the dispatched application is present in the pre-loaded app management table 700 (step S2703). If the OS determines that the ID of the dispatched application is not present in the pre-loaded app management table 700 (step S2703: NO), the OS loads the dispatched application onto the RAM 211 (step S2704) and executes the dispatched application (step S2705).

If the OS determines that the ID of the dispatched application is present in the pre-loaded app management table 700 (step S2703: YES), the OS determines whether the pre-loading of the dispatched application has been completed (step S2706). If the OS determines that the pre-loading of the dispatched application is completed (step S2706: YES), the procedure advances to step S2709.

If the OS determines that the pre-loading of the dispatched application is not yet completed (step S2706: NO), the OS loads onto the RAM 211, the portion that has not yet been pre-loaded (step S2707); concatenates the loaded partial code with each other; expands the concatenated partial code on the RAM 211; and thereby, produces the context of the dispatched application (step S2708). The OS executes the dispatched application (step S2709) and updates the fragment area management table 600 and the pre-loaded app table (step S2710).

If the OS determines that the ON-setting of the start-up flag has been detected (step S2702: ON SETTING), the OS releases the sleep state of the parallel pre-loaders (step S2703) and the procedure returns to step S2702. If the OS determines that the ending of the processing of all the applications has been detected (step S2702: PROCESS END), the series of operations comes to an end.

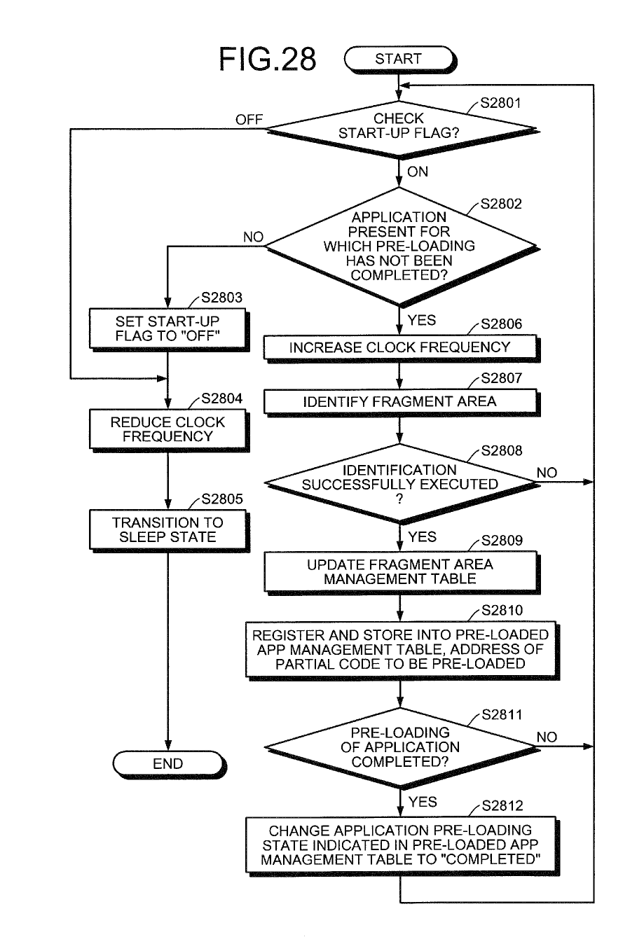

FIG. 28 is a flowchart of an example of a procedure for a pre-loading process executed by the parallel pre-loader. The parallel pre-loader checks the start-up flag (step S2801). If the parallel pre-loader determines that the start-up flag indicates “OFF” (step S2801: OFF), the procedure advances to step S2804. If the parallel pre-loader determines that the start-up flag indicates “ON” (step S2801: ON), the parallel pre-loader refers to the pre-loaded app management table 700 and determines whether an application is present for which “uncompleted” is set in the overall application pre-loading state field 705 (step S2802).

If the parallel pre-loader determines that no application is present for which “uncompleted” is set in the overall application pre-loading state field 705 (step S2802: NO), the parallel pre-loader sets the start-up flag to be “OFF” (step S2803) and reduces the clock frequency (step S2804). For example, the parallel pre-loader changes, in the clock supply circuit 207, the value of the register that can vary the frequency of the clock to be supplied to the CPU executing the parallel pre-loader. The frequency is set at 100 [MHz] for the clock that is supplied to the CPU executing the parallel pre-loader. The parallel pre-loader transitions to the sleep state (step S2805), and the series of operations comes to an end.

If the parallel pre-loader determines at step S2802 that an application is present for which “uncompleted” is set in the overall application pre-loading state field 705 (step S2802: YES), the parallel pre-loader increases the clock frequency (step S2806). For example, the parallel pre-loader changes, in the clock supply circuit 207, the value of the register that can vary the frequency of the clock to be supplied to the CPU executing the parallel pre-loader. The frequency is set at 200 [MHz] of the clock to be supplied to the CPU executing the parallel pre-loader.

The parallel pre-loader identifies the fragment areas for the application to be pre-loaded, from among the plural fragment areas (step S2807) and determines whether the identification is successfully executed (step S2808). If the parallel pre-loader determines that the identification has been successfully executed (step S2808: YES), the parallel pre-loader updates the fragment area management table 600 (step S2809), registers the address of the partial code to be pre-loaded, into the pre-loaded app management table 700, and stores the partial code into the identified fragment area (step S2810).

The parallel pre-loader determines whether the parallel pre-loader has completed the pre-loading of the application (step S2811). If the parallel pre-loader determines that the parallel pre-loader has completed the pre-loading of the application (step S2811: YES), the parallel pre-loader changes the overall application pre-loading state field 705 of the pre-loaded app management table 700 and sets therein “completed” (step S2812) and the procedure returns to step S2801. If the parallel pre-loader determines that the parallel pre-loader has not yet completed the pre-loading of the application (step S2811: NO), the procedure returns to step S2801.

As described, according to the system and the data loading method, the program of the application that is to be executed other than a program currently under execution by the plural processors is pre-loaded into the fragment areas of the memory. Thereby, the risk of being overwritten can be distributed without causing swapping. Therefore, the processing speed when the application is started up can be increased and thereby, response can be improved.

When no program that is to be pre-loaded by the pre-loader is present, the mode of the pre-loader is set to the sleep mode. Thus, the pre-loader is not always operated and thereby, reductions in power consumption can be facilitated.

When the predetermined relation is satisfied by the estimated time period elapsing until the time when the application to be executed is executed and the time period necessary for the pre-loading, the setting of the sleep mode is released. Thereby, the application to be executed can be pre-loaded before the start-up instruction for the application to be executed is received and therefore, the processing speed when the application is started up can be increased.

A first table is included that is used to manage the fragment areas, and the state of the use of the fragments is stored in the first table. Thereby, coincidence of the pre-loading destinations can be prevented and the fragment areas can efficiently be used.

A second table is included that is used to manage the program of each of the applications, and the time period that is necessary for pre-loading the program of the application is stored in the second table. Thereby, the application to be executed can be pre-loaded before the start-up instruction for the application to be executed is received and therefore, the processing speed when the application is started up can be increased.

The frequency of the operation clock used in the pre-loading of the program to be executed is set to be higher than that of the operation clock used in the execution of the program. Thereby, the speed at which the pre-loading is executed can be increased.

The data loading method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to the system and the data loading method, an effect is achieved that the processing speed at the time of application start up can be increased, thereby enabling the response to be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A system comprising:
a plurality of processors;
a storage that stores a program currently under execution by the processors; and
a preloader that preloads a target program into a fragment area of the storage, the target program excepting forex the program currently under execution by the processors.

2. The system according to claim 1, wherein
the pre-loader is set to be in a sleep mode when no program that is to be pre-loaded is present.

3. The system according to claim 2, wherein
the pre-loader is released from the sleep mode when a predetermined relation is satisfied by an estimated time period elapsing until a time when the target program is executed and a time period for pre-loading the target program.

4. The system according to claim 1, further comprising
a first table for managing the fragment area, wherein
the first table indicates a state of use of the fragment area.

5. The system according to claim 1, further comprising
a second table for managing the target program, wherein
the second table indicates a time period for pre-loading the target program.

6. A data loading method executed by a processor, the data loading method comprising:
executing a program that is loaded in a memory area of a storage;
pre-loading into a plurality of fragment areas of the storage, a target program excepting forex the program;
concatenating the target program that is in the plural fragment areas and expanding the concatenated target program on the memory area; and
executing the target program.

7. The data loading method according to claim 6, wherein
the pre-loading include starting the pre-loading when a predetermined relation is satisfied by an estimated time period elapsing until a time when the target program is executed and a time period for pre-loading the target program.

8. The data loading method according to claim 6, wherein
the pre-loading includes pre-loading when the fragment areas store a portion of the target program, a remaining portion of the target program,
the concatenating includes concatenating the remaining portion and the portion of the target program stored in the fragment areas, and expanding the concatenated portions on the memory area.

9. The data loading method according to claim 6, wherein
the pre-loading includes pre-loading the target program when the program is not under execution by the processor.

10. The data loading method according to claim 6, further comprising
setting a frequency of an operation clock used when the target program is pre-loaded to be higher than a frequency of the operation clock used when the program is executed.
